(19) United States
(12) Patent Application Publication
(10) Pub. No.: US 2006/0118031 A1
(43) Pub. Date: Jun. 8, 2006

(54) Bookmark

(76) Inventor: Denise Robin Wolfbiss, Woodbury, NY (US)

Correspondence Address: DENISE R. WOLFBISS, 1 MAGNOLIA LANE, WOODBURY, NY, 11797, US

(21) Appl. No.: 11/294,057

(22) Filed: Dec. 5, 2005

Related U.S. Application Data
(60) Provisional application No. 60/633,785, filed on Dec. 7, 2004.

(51) Int. Cl. B42D 9/00

(52) U.S. Cl. 116/234

(57) ABSTRACT

A substantially transparent, elastic wraparound bookmark that is multi-functional. There is the need for a bookmark that holds pages down while reading, especially when outdoors or doing activities like exercising. As the reader turns the pages, the substantially transparent elastic line is lifted and the subsequent pages are slipped under. The reader can read without pages flipping over, and does not have to remove the bookmark at any time, even while reading because it is substantially transparent. The elastic line forming the wraparound loop is unique and offers the advantages that while holding the pages down and holding a reader's place, there is also no interference with the activity of reading itself, because the reader can read through the substantially transparent line. In addition, the bookmark of the present invention has additional advantages over other bookmarks in that it will not fall out, will not lose its place and does not have to be removed from the book to be used.

### RELATED APPLICATIONS

The present application is a continuation-in-part application of U.S. Provisional Patent application, Ser. No. 60/633785, filed Dec. 7, 2004, by Denise R. Wolfbiss, included by reference herein and for which benefit of the priority date is hereby claimed.

### FIELD OF THE INVENTION

The present invention relates to bookmarks and, more particularly, to a substantially transparent, elastic wraparound bookmark that holds pages down while reading, holds the reader's place, can remain in the book while reading because it can be read through, and never has to be removed from the book.

### BACKGROUND OF THE INVENTION

There is the need for an improved bookmark that never has to leave the book, even while reading, thus insuring a reader never loses his or her place and never loses the bookmark. Additionally there is the need for a bookmark to securely hold one side of the pages down while reading so pages do not blow or flip over and the book can be read while at the beach, exercising, blowing hair or other activities. The primary function of a typical bookmark is to hold a reader's place in a book so the reader may return to that place when he or she resumes reading. These prior art bookmarks are removed while reading and replaced when the reader stops, and often fall out accidentally. Either way there is the great chance that the reader loses his or her place, and possibly even the bookmark. There is the need for a bookmark that NEVER has to leave the book, even while reading, and that does not interfere with reading while it is being used. A substantially transparent elastic wraparound bookmark provides a solution to all of these problems that no other bookmark can do.

While there is prior art that may address bookmark problems individually, there is no existing prior art that accomplishes all of the features that the present invention provides. Most people use a piece of paper, or a plastic or paper bookmark to hold their place in a book. Some use nothing at all, but instead turn the corner of the page down to mark their place. Other types of bookmarks use clips that fasten to a book's pages. There are adjustable bookmarks as prior art, all different from the proposed invention. U.S. Pat. No. 6,854,417 provides for an adjustable bookmark solely to hold a reader's place on any size reading material. There are several prior art elastic bookmarks that also do not meet the claims of the present invention. U.S. Pat. No. 1,809,943 describes elastic and inelastic bands together with clips and it does not encircle the pages. U.S. Pat. No. 6,279,957 describes an elastic bookmark that solely retains the last page read. U.S. Pat. No. 5,622,387 uses elastic to keep a book cover closed. U.S. Pat. No. 5,427,414 uses elastic cord to stretch horizontally across the width of the book. It attempts to be a combination bookmark and page-holder. It consists of a semi-flexible material such as a hard plastic strip attached to stretchable cord. The book stays open because this strip holds the book open horizontally. The reader then has to rotate the strip vertically to hold the place in the book. None of these “elastics” are substantially transparent.

These paper or plastic bookmarks all can easily fall out of books, thus losing the reader's place as well as the bookmark. Clip-type bookmarks can potentially damage the pages of the book. They also must be removed and repositioned during reading. The adjustable bookmarks provide the sole function of retaining a reader's page on any size reading material. They must be removed during reading and do nothing to hold the pages down while doing so. While some of the “elastic” bookmarks address the problem of retaining the last page read; they must be removed during reading. By removing the bookmark during reading, the reader risks losing not only their place, but the bookmark as well. Additionally nothing is being done to hold the pages down. U.S. Pat. No. 5,427,414 holds the pages down with a horizontal clear or opaque strip which has to be maneuvered during reading to turn the pages. When the reader is done reading, the strip must be repositioned into a vertical position to function as a placeholder. This requires significant and frequent movement of the bookmark to accomplish both functions. All of this repeated movement is not only inconvenient but also causes damage to the book. No prior art offers a convenient bookmark that simultaneously securely marks a readers place in a book, AND holds the pages down AND never has to leave the book to be repositioned.

It is therefore an object of the invention to provide a substantially transparent, elastic, wraparound bookmark that securely holds the reader's place.

It is another object of the invention to provide a substantially transparent, elastic, wraparound bookmark that never has to leave a book.

It is another object of the invention to provide a substantially transparent, elastic, wraparound bookmark that is clear and can remain in book without interfering with reading.

It is another object of the invention to provide a substantially transparent, elastic wraparound bookmark that is stretchable and can fit most books.

It is another object of the invention to provide a substantially transparent, elastic wraparound bookmark that holds pages down and keeps them from moving while reading.

It is another object of the present invention to provide a substantially transparent, elastic wraparound bookmark that will never fall out of the book because it wraps around the cover and pages of the reading material.

### SUMMARY OF THE INVENTION

In accordance with the present invention, there is provided a substantially transparent, elastic wraparound bookmark that holds pages down and keeps them from moving while reading, without interfering with reading by allowing reader to read through the bookmark, and securely holds a readers place when they have stopped reading and never has to be removed from the book.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a full view of a substantially transparent, elastic wraparound bookmark according to the present invention;

FIG. 2 is a side view of a substantially transparent, elastic wraparound bookmark according to the present invention; and

FIG. 3 is a front view of a substantially transparent, elastic wraparound bookmark according to the present invention.

FIG. 4 is a full view of a substantially transparent, elastic wraparound bookmark with shortening snap according to the present invention.

### DESCRIPTION OF THE PREFERRED EMBODIMENT

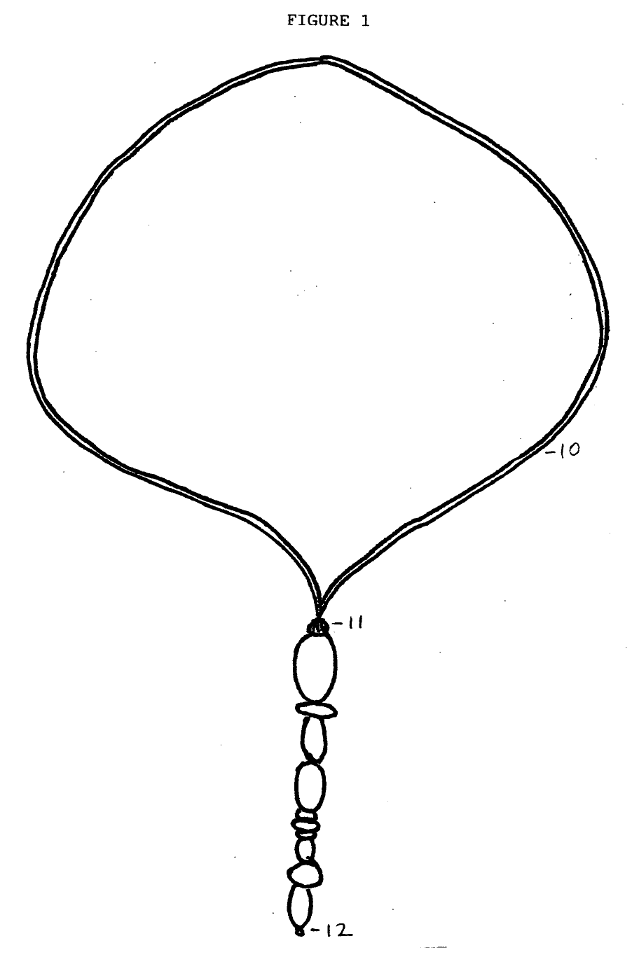

FIG. 1 is a full view of a SUBSTANTIALLY TRANSPARENT ELASTIC WRAPAROUND BOOKMARK according to the present invention. The 1 mm clear stretchable line 10 is shown forming a 16″ loop. At 16″ the line is tied in a knot. A large metal crimp bead 11 is threaded over the knot. It has been tightly crimped to secure the knot. Decorative addition is strung on remaining 3-4″ of 1 mm substantially transparent elastic line. A small metal crimp bead 12 is tightened at the end of the decorative addition.

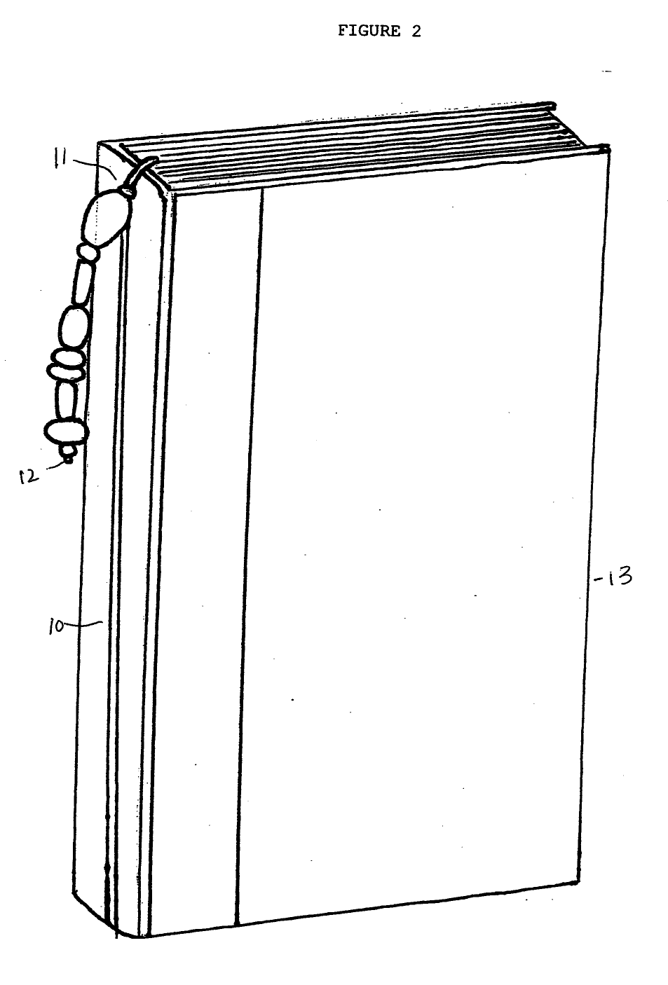

FIG. 2 is a side view of a SUBSTANTIALLY TRANSPARENT ELASTIC WRAPAROUND BOOKMARK according to the present invention. This side view shows the bookmark in use holding the place in the reading material 13 with the 1 mm substantially transparent elastic line 10 wrapped around the pages in the book. The other half of the loop of the 1 mm clear stretchable line is shown down the spine of the book. The large metal crimp bead 11 is shown at top and small metal crimp bead 12 is shown at bottom of decorative addition.

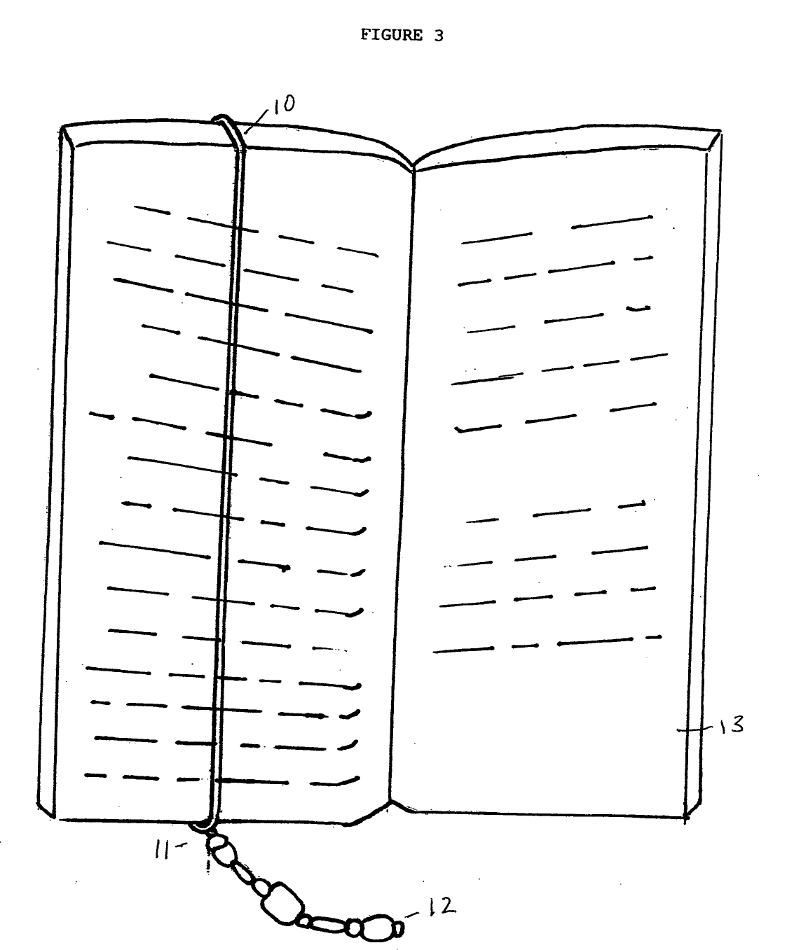

FIG. 3 is a front view of a SUBSTANTIALLY TRANSPARENT ELASTIC WRAPAROUND BOOKMARK according to the present invention. The front view shows the bookmark as used in open reading material 13. The 1 mm substantially transparent elastic line 10 is looped over one side of the reading material whereby it is positioned anywhere on the page. The scattered lines represent words in reading material that are not obstructed by the 1 mm substantially transparent elastic line. Large metal crimp bead 11 is shown on top end of decorative addition. Small metal crimp bead 12 is shown on bottom of decorative addition.

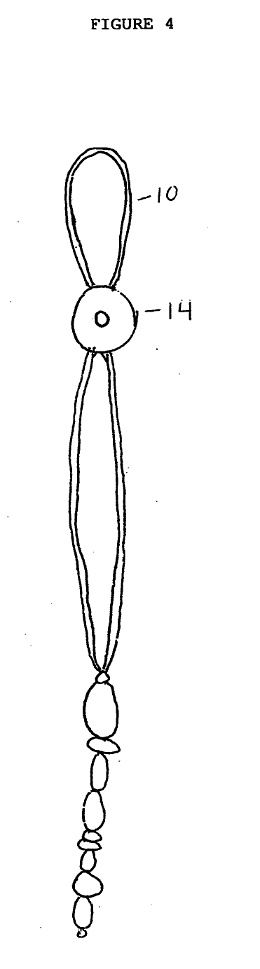

FIG. 4 is a full view of a SUBSTANTIALLY TRANSPARENT ELASTIC WRAPAROUND BOOKMARK ACCORDING TO THE PRESENT INVENTION. The full view shows the bookmark as sized using a shortening snap 14. The end of the loop of 1 mm substantially transparent elastic line 10 is threaded through and over and through the bottom half of the shortening snap. The snap is snapped closed and may be adjusted to fit reading material of varying sizes.

One embodiment of the present invention uses Stretch Magic, 1 mm, strong and stretchy bead and jewelry line. This particular line has the advantage of being substantially transparent and extremely elastic, and is capable of being stretched many times and returning to its original dimension. An additional embodiment of the present invention allows the size of the loop to be adjusted to accommodate different size reading materials by threading the line through and over a size 4 snap and snapping closed at the desired spot.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A device for marking a place in a book comprising a substantially transparent and elastic means, said means describing a closed loop.

2. The device of claim 1, wherein said closed loop is formed by knotting said substantially transparent and elastic means.

3. The device of claim 1, wherein said closed loop is formed in a continuous, unbroken piece.

4. The device of claim 1, wherein the diameter of said closed loop is adjustable.

5. The device of claim 4 comprising a re-settable snap that serves as the means of adjusting the diameter of said closed loop.

6. The device of claim 1, wherein substantially transparent and elastic means comprises a filament having a diameter in the range of 0.5 mm to 1.5 mm.

7. The device of claim 1 comprising a means attached to said substantially transparent and elastic means sufficient to facilitate the movement of said substantially transparent and elastic means by a user.

8. The device of claim 7, wherein said attached means comprises one or more beads.

9. The device of claim 7, wherein said attached means comprises one or more tabs.
